(19) United States
(12) Patent Application Publication
(10) Pub. No.: US 2012/0317560 A1
(43) Pub. Date: Dec. 13, 2012

(54) METHOD FOR OPTIMIZING BINARY CODES IN LANGUAGE HAVING ACCESS TO ZONED DECIMAL TYPE VARIABLE, OPTIMIZATION APPARATUS AND COMPUTER PROGRAM FOR THE SAME

(75) Inventor: Motohiro Kawahito, Kanagawa (JP)

(73) Assignee: International Business Machines Corporation, Armonk, NY (US)

(21) Appl. No.: 13/591,330

(22) Filed: Aug. 22, 2012

Related U.S. Application Data
(63) Continuation of application No. 13/483,300, filed on May 30, 2012.

(30) Foreign Application Priority Data
May 31, 2011 (JP) 2011-121446

(51) Int. Cl. G06F 9/45

(52) U.S. Cl. 717/151

(57) ABSTRACT

An optimization technique for optimizing binary codes in a language having access to a zoned decimal type variable and applicable to binary codes including instructions which can cause side effects. The optimization technique includes: detecting, for each variable, an area including access to a zoned decimal type variable and not including an instruction that can cause a side effect, from the binary codes read into a memory; and performing, in the detected area, a process for converting a zoned decimal type variable to a binary type variable, a process for deleting such a pack/unpack code that a converted result does not change even in case the pack/unpack code is deleted, from the binary codes, or a process for performing combination of the processes.

### CROSS REFERENCE TO RELATED APPLICATION

This application is a continuation of and claims priority from U.S. application Ser. No. 13/483,300 filed on May 30, 2012, which in turn claims priority under 35 U.S.C. 119 from Japanese Application 2011-121446, filed May 31, 2011, the entire contents of both applications are incorporated herein by reference.

### BACKGROUND OF THE INVENTION

1. Field of the Invention

The present invention relates to a technique for optimizing binary codes in a language having access to a zoned decimal type variable, particularly binary codes in COBOL.

2. Description of the Related Art

COBOL, a high-level language created in the United States in 1959, has a long history among various languages. Because of its capability in efficient development of business-processing programs, the COBOL language is still used in basic systems (e.g., mainframes). For example, COBOL binary code is often used on IBM® System z®, a mainframe available from International Business Machines Corporation.

In COBOL, if nothing is specified as the Int type, numbers are represented as numbers of the zoned decimal type (also called the external decimal type). Also in COBOL, performing a general binary operation requires a BINARY modifier. However, many COBOL programmers specify nothing as the Int type. Consequently, the zoned decimal type is often used in COBOL.

The zoned decimal type is internally converted into the packed type (also called the internal decimal type) each time COBOL is executed. This results in significant decreases in performance and speed.

In order to improve such decreases in performance and speed, it is a common practice to optimize COBOL source code at the time of compiling. Exemplary optimization is type conversion of the source code from decimal type operations to binary type operations.

JP3-102427A describes performing type conversion on a COBOL source program. The type conversion involves comparing the number of clocks.

JP5-108370A describes counting the frequency of update and the frequency of reference of variables and numerical value data in a source program with a COBOL language compiler, providing an allocation for the binary type besides a type specified by the source program for variables and numerical value data having the frequency of update as higher than the frequency of reference, and generating an object program in which operations are performed as the binary type and finally converted into the type specified by the source program.

As described above, since the COBOL language has a long history, there may be cases where only binary codes in COBOL (hereinafter also referred to simply as “binary codes”) exist (or are stored), and their source codes in COBOL (hereinafter also referred to simply as “COBOL codes”) are lost. In such cases, it is impossible to optimize the binary codes by recompiling the COBOL codes. Therefore, there is a demand for optimizing not COBOL codes but binary codes themselves.

There exists a technique for reducing overhead due to zoned decimal numbers at the time of compiling COBOL codes. For example, in both of JP3-102427A and JP5-108370A, type conversion is performed on source codes. That is, in both of these patent literatures, optimization of COBOL codes is described. However, neither one describes optimization of binary codes. As for binary codes, it is necessary to consider instructions which can cause side effects. If the instructions which can cause side effects are not taken into consideration, a result may be different from the result of the original program. Therefore, the techniques described in JP3-102427A and JP5-108370A in which type conversion of source codes is performed cannot be immediately applied to optimization of binary codes.

In JP3-102427A, it is described that type-convertible items are extracted. In this same literature, it is further described that in the type-convertible items, convertible items should be working variables and the like; however, type conversion should not be performed on items used for an interface with other programs because process inconsistency may be caused by type conversion; and that type conversion should not either be performed on items referred to from other type attributes with the use of a redefinition function of a high-level language, even if they are working items in the program. In other words, since JP3-102427A does not regard such items that can cause process inconsistency by type conversion as a subject for optimization, a chance for optimization is lost.

An estimate of the cost for type conversion is calculated by the number of clocks (the number of cycles) in JP3-102427A. In JP5-108370A, the estimate is determined based on whether the frequency of update of variables and numerical value data is higher than the frequency of reference. However, neither JP3-102427A nor JP5-108370A takes into consideration the frequency of execution in each block when the cost is calculated to determine whether or not to perform optimization. Therefore, the result of the cost estimation is not accurate.

### SUMMARY OF THE INVENTION

In order to overcome these deficiencies, the present invention provides A method for optimizing binary codes in a language having access to a zoned decimal type variable, including: detecting, for each variable, an area including access to a zoned decimal type variable and not including an instruction that possibly causes a side effect, from the binary codes read into a memory; and performing, in the detected area, at least one of a process for converting the zoned decimal type variable to a binary type variable and a process for deleting pack/unpack code such that a converted result does not change even upon a condition that the pack/unpack code is deleted from the binary codes.

According to another aspect, the present invention provides An apparatus for optimizing binary codes in a language having access to a zoned decimal type variable, the apparatus including: a detection section for detecting, for each variable, an area including access to a zoned decimal type variable and not including an instruction that possibly causes a side effect; and a processing section for performing, in the detected area, at least one of a process for converting a zoned decimal type variable to a binary type variable and a process for deleting pack/unpack code such that a converted result does not change even upon a condition that the pack/unpack code is deleted from the binary codes.

According to yet another aspect, the present invention provides An apparatus for optimizing binary codes in a language having access to a zoned decimal type variable, the apparatus including: a memory for reading the binary codes; a processor for optimizing the binary codes on the memory; a detection section for detecting, for each variable, an area including access to a zoned decimal type variable and not including an instruction that possibly causes a side effect; and a processing section for performing, in the detected area, at least one of a process for converting a zoned decimal type variable to a binary type variable and a process for deleting pack/unpack code such that a converted result does not change even upon a condition that the pack/unpack code is deleted from the binary codes.

### BRIEF DESCRIPTION OF THE SEVERAL VIEWS OF THE DRAWINGS

FIG. 1 shows a basic block diagram of computer hardware in an embodiment of the present invention;

FIG. 2 shows a functional block diagram for performing a process of optimizing binary code in a language having access to a zoned decimal type variable in an embodiment of the present invention;

FIG. 3A shows flowcharts of the entire process of optimizing binary code in a language having access to a zoned decimal type variable according to an embodiment of the present invention;

FIG. 3B shows a flowchart of the entire process of optimizing binary code in a language having access to a zoned decimal type variable in an embodiment of the present invention;

FIG. 4 shows a flowchart of a process of detecting an area including access to a zoned decimal type variable and not including an instruction that can cause a side effect (steps 302, 312, and 322) in the optimization process shown in FIG. 3A;

FIG. 5 shows a flowchart of a process of generating a set (hereinafter also referred to as GEN(B)) of variables accessed after an instruction that can cause a side effect in each block of the binary code, and a set (hereinafter also referred to as KILL(B)) containing all variables in each block if an instruction that can cause a side effect exists (whereas KILL(B) is an empty set if an instruction that can cause a side effect does not exist) (step 402) in the detection process shown in FIG. 4;

FIG. 6 shows a flowchart of a process of setting the content of VSET set information as additional information for an instruction in each block (step 404) in the detection process shown in FIG. 4;

FIG. 7 shows a flowchart of a process of optimizing residue calculation instructions for digit alignment (steps 305, 315, and 325) in the optimization process shown in FIG. 3A;

FIG. 8 shows a flowchart of a process of performing a “deletion process for one residue calculation instruction” in residue calculation instructions REM (step 703) in the process of optimizing the residue calculation instructions shown in FIG. 7;

FIG. 9 shows a flowchart of a process AnalyzeUSE(REM, I, NDIGITS) for checking whether a residue is necessary or not for each use I of the residue calculation instruction REM (step 804) in the process of optimizing the residue calculation instruction shown in FIG. 8;

FIG. 10 shows a flowchart of a process AnalyzeDEF(J, NDIGITS) for checking whether a residue is necessary or not for each definition J of the residue calculation instruction REM (step 806) in the process of optimizing the residue calculation instruction shown in FIG. 8;

FIG. 11 is a diagram for illustrating what VSET contains as the content of the set information included in the VSET, which is a working area, shown in step 608 of FIG. 6;

FIG. 12 shows COBOL code, binary code to be optimized, and code optimized by converting zoned decimal type variables into binary type variables according to an embodiment of the present invention;

FIG. 13 shows COBOL code, binary code to be optimized, and code optimized by converting zoned decimal type variables into binary type variables according to an embodiment of the present invention;

FIG. 14 shows COBOL code, binary code to be optimized, and code optimized by deleting pack/unpack binary codes for a variable that is updated idx according to an embodiment of the present invention; and

FIG. 15 shows COBOL code, binary code to be optimized, and code optimized by deleting a pack/unpack binary code for a variable that is not updated idx2 according to an embodiment of the present invention.

### DETAILED DESCRIPTION OF THE PREFERRED EMBODIMENTS

Embodiments of the present invention will be described below with reference to the drawings. It is to be understood that the embodiments are for illustrating preferable forms of the present invention and are not intended to limit the scope of the present invention to what is set forth herein. Throughout the drawings, like symbols denote like objects unless otherwise specified.

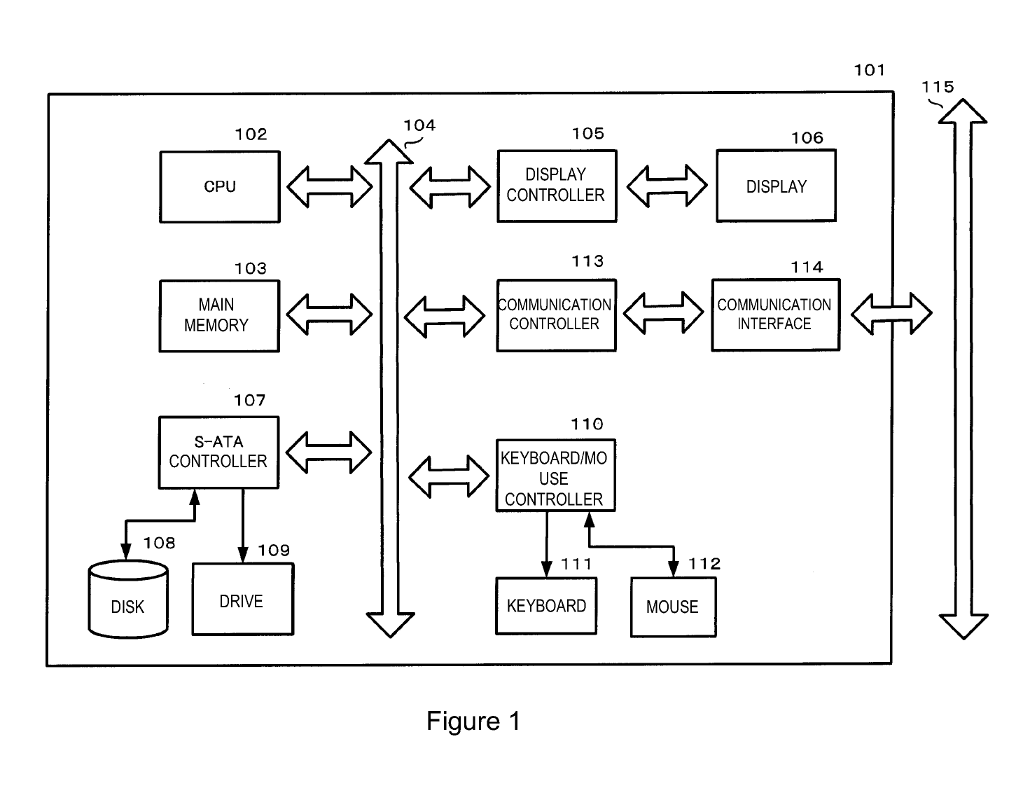

FIG. 1 shows a basic block diagram of computer hardware in an embodiment of the present invention.

A computer 101 includes a CPU 102 and a main memory 103, which are connected to a bus 104. The CPU 102, preferably based on a 32-bit or 64-bit architecture, may be a CPU of a Core™ i series, a Core™ 2 series, an Atom™ series, a Xeon® series, a Pentium® series, or a Celeron® series of Intel® Corporation, or a Phenom™ series, an Athlon™ series, a Turion™ series, or a Sempron™ series of Advanced Micro Devices, Inc., for example. A display 106, for example a liquid crystal display (LCD), may be connected to the bus 104 via a display controller 105. The display 106 is used for displaying, through an appropriate graphic interface, information about a computer connected to a network via a communication line and information about software running on the computer, in order to manage the computer. A disk 108, for example a hard disk or a silicon disk, and a drive 109, for example a CD, DVD, or BD drive, are also connected to the bus 104 via a SATA or IDE controller 107. A keyboard 111 and a mouse 112 may further be connected to the bus 104 via a keyboard/mouse controller 110 or a USB bus (not shown).

The disk 108 optionally stores an operating system, a processing program for generating COBOL code, a COBOL compiler for compiling COBOL code, and other programs, as well as COBOL code, binary code, and optimized code, which are all stored as loadable into the main memory.

The drive 109 is used as necessary for installing programs from a CD-ROM, a DVD-ROM, or a BD into the disk 108.

A communication interface 114 is based on the Ethernet protocol, for example. The communication interface 114, connected to the bus 104 via a communication controller 113, is responsible for physically connecting the computer 101 to a communication line 115 and provides a network interface layer for the TCP/IP communication protocol of communication functions of the operating system in the computer 101. The communication line may be in a wired LAN environment, or a wireless LAN environment based on a wireless LAN connection standard, for example IEEE 802.11a/b/g/n.

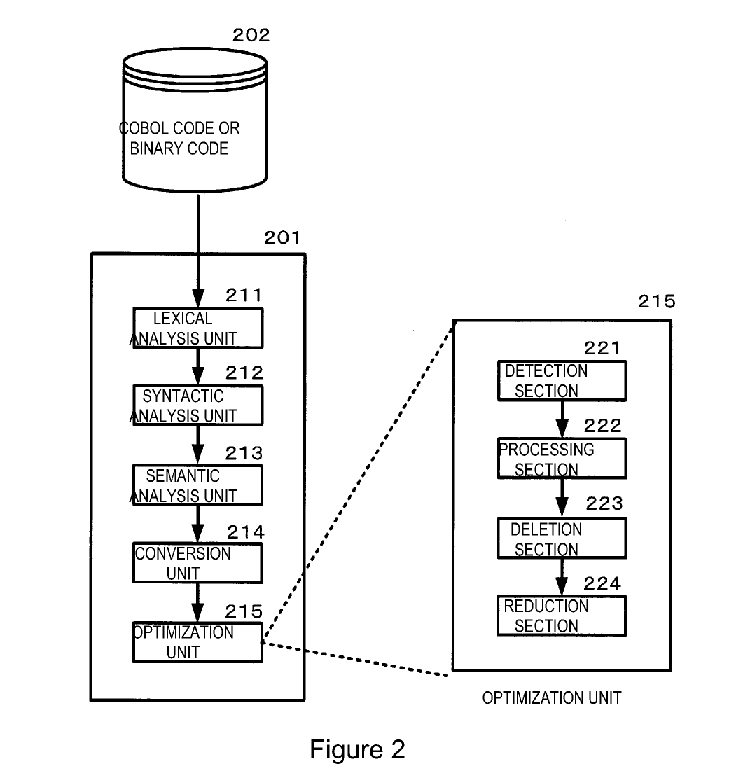

FIG. 2 shows a functional block diagram for performing a process of optimizing binary code in a language having access to a zoned decimal type variable in an embodiment of the present invention.

A computer 201 corresponds to the computer 101 in FIG. 1. The computer 201 includes the components shown in the computer 101 in FIG. 1, for example the CPU and the memory. The computer 201 may be a binary code optimization device or a compiler device for performing an optimization technique according to the present invention.

A storage unit 202 stores source code in a language having access to a zoned decimal type variable (e.g., COBOL source code) and binary code in a language having access to a zoned decimal type variable (e.g., COBOL binary code). The storage unit 202 also stores the binary code optimized through the optimization technique according to the present invention.

As an example of source code in a language having access to a zoned decimal type variable, the following description uses COBOL source code (hereinafter also referred to simply as COBOL code). Similarly, as an example of binary code in a language having access to a zoned decimal type variable, the following description uses COBOL binary code (hereinafter also referred to simply as binary code).

The storage unit 202 may be a storage medium provided within the computer 201 or may be an external storage medium connected to the computer 201 directly or over a network. For example, the storage unit 202 may be, although not limited to, a hard disk or a solid state disk.

The computer 201 includes at least an optimization unit 215 for performing the optimization technique according to the present invention, and may optionally include a lexical analysis unit 211, a syntactic analysis unit 212, and a semantic analysis unit 213. If the computer 201 includes a compiler (not shown), the compiler can include the lexical analysis unit 211, the syntactic analysis unit 212, the semantic analysis unit 213, and the optimization unit 215, as well as a conversion unit 214 for converting COBOL code into binary code.

The lexical analysis unit 211 performs lexical analysis of input COBOL code or binary code.

The syntactic analysis unit 212 performs syntactic analysis of the result of the lexical analysis by the lexical analysis unit 211.

The semantic analysis unit 213 performs semantic analysis of the result of the syntactic analysis by the syntactic analysis unit 212.

The conversion unit 214 converts the COBOL code into binary code.

The optimization unit 215 optimizes the binary code through the optimization technique according to the present invention. Besides the optimization technique according to the present invention, the optimization unit 215 can also involve other optimization techniques, for example a source code optimization technique and a binary code optimization technique.

The optimization unit 215 includes at least a detection section 221 and a processing section 222, and may optionally include a deletion section 223 and/or a reduction section 224. The detection section 221, the processing section 222, the deletion section 223, and the reduction section 224 may be implemented by a computer program having a function of providing an activation signal or may be implemented by dedicated hardware (circuit). Specifically, in a computer program product according to the present invention, if the subject of each step can be any of the detection section 221, the processing section 222, the deletion section 223, and the reduction section 224, part or all of each section 221 to 224 can be implemented by dedicated hardware (circuit), or sections not implemented by dedicated hardware (circuit) or all the sections 221 to 224 can be implemented as non-transient program code.

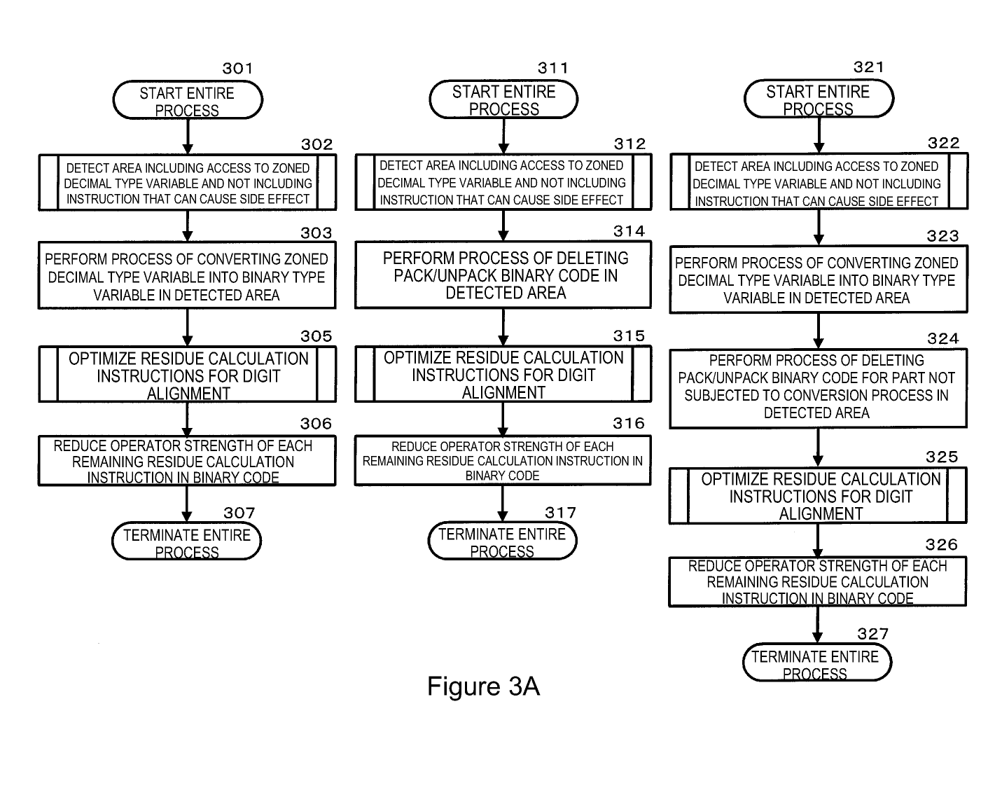

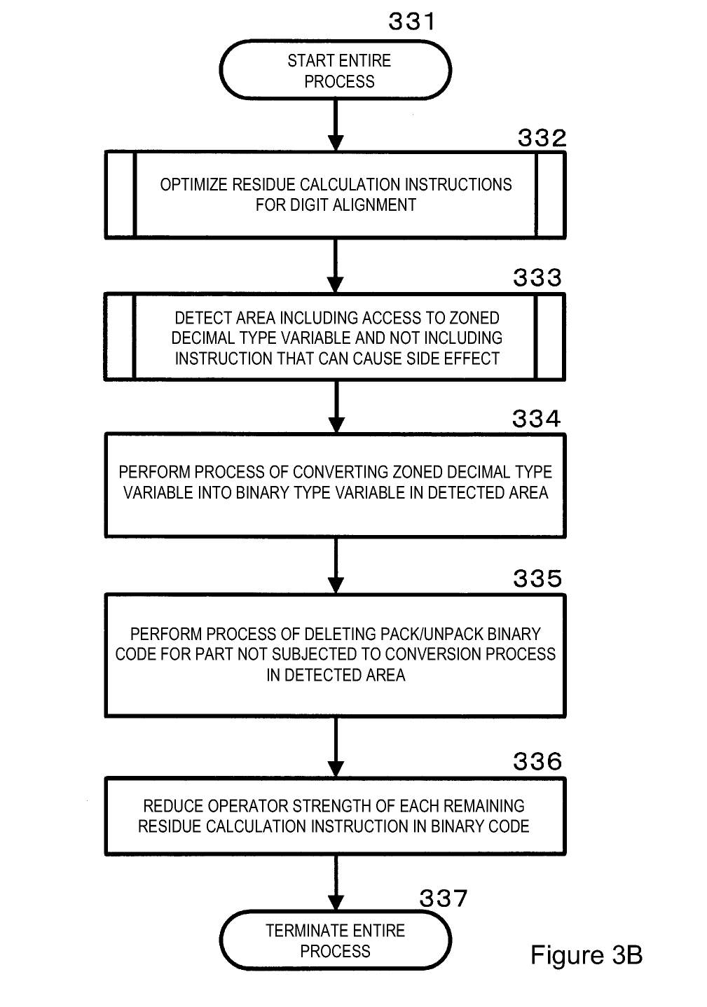

The detection section 221 detects, for each variable, an area including access to a zoned decimal type variable and not including an instruction that can cause a side effect (see steps 302, 312, and 322 in FIG. 3A below).

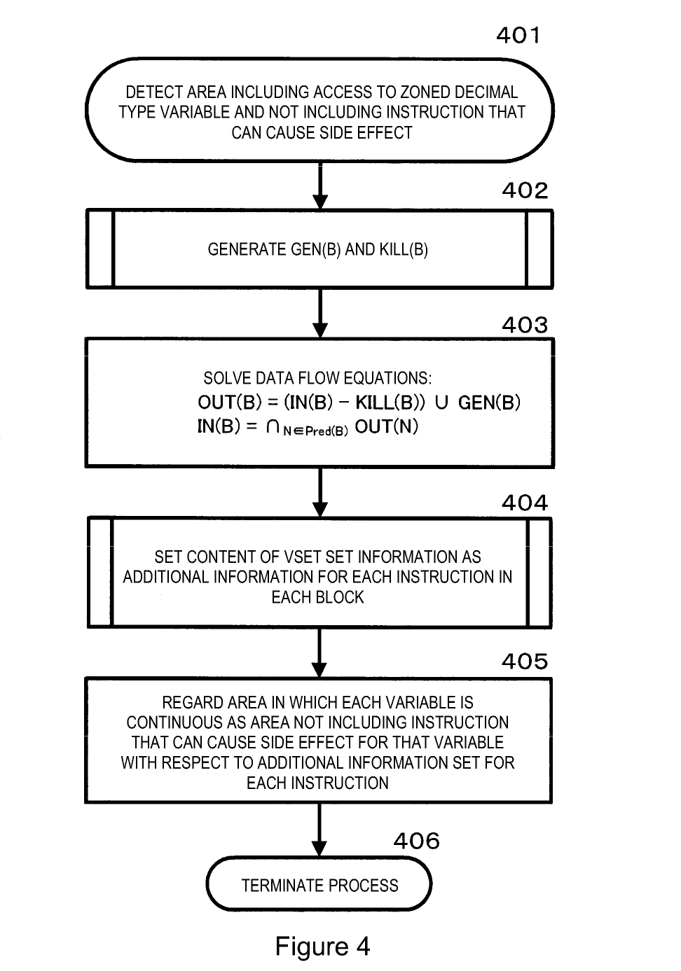

In order to detect this area, the detection section 221 performs the following process (1) to (4) (see FIGS. 4 to 6 below):

(1) the detection section 221 generates GEN(B) and KILL(B) in each block of the binary code;

(2) the detection section 221 determines a set (hereinafter also referred to as IN(B)) of variables at the beginning of each block from a set (hereinafter also referred to as OUT(B)) of variables at the end of each block, the GEN(B), and the KILL(B);

(3) the detection section 221 sets set information modified at each instruction in each block as additional information for the instruction in the block; and

(4) the detection section 221 regards an area in which each variable is continuous as an area not including an instruction that can cause a side effect for the variable with respect to the additional information set for each instruction. The set information is determined on the basis of the IN(B).

The GEN(B) is a set of variables accessed after an instruction that can cause a side effect in each block of the binary code.

The KILL(B) is a set of all variables in each block of the binary code if an instruction that can cause a side effect exists (whereas it is an empty set if an instruction that can cause a side effect does not exist).

The detection section 221 performs the following process (1a) to (1c) in the generation in process (1):

(1a) the detection section 221 determines whether an instruction in each block is an access to a variable and whether the instruction is an instruction that can cause a side effect;

(1b) the detection section 221 repeats the determination for each instruction in the order of execution; and

(1c) the detection section 221 generates the GEN(B) and the KILL(B) from the result of the determination.

The detection section 221 determines the OUT(B) and the KILL(B) from data flow equations below. OUT(N) is a set of variables at the end of a block N immediately before a block B being processed with the equations below, the variables being accessed after an instruction that can cause a side effect.

OUT(B)=(IN(B)−KILL(B))∪GEN(B)

IN(B)=∩NεPred(B)OUT(N)

The detection section 221 performs the following process (3a) to (3c) in the setting of the additional information in process (3):

(3a) the detection section 221 determines whether an instruction in each block is an access to a variable and whether the instruction is an instruction that can cause a side effect, and modifies the set information of the IN(B);

(3b) the detection section 221 sets the set information modified at each instruction in each block as the additional information for the instruction in the block; and

(3c) The detection section 221 repeats the determination and the modification of the set information of the IN(B) for each instruction in the order of execution. The set information is determined on the basis of the IN(B).

The processing section 222 performs, in the detected area, one of the following processes: converting a zoned decimal type variable into a binary type variable (see step 303 in FIG. 3A); deleting, from the binary code, a pack/unpack code such that a converted result does not change even if the pack/unpack code is deleted (see step 314 in FIG. 3A); and a combination of these processes (see steps 323 and 324 in FIG. 3A). A pack/unpack code is a known instruction in COBOL.

The processing section 222 can perform the process of converting a zoned decimal type variable into a binary type variable using any technique known by those skilled in the art.

The processing section 222 may perform the process of converting a zoned decimal type variable into a binary type variable if an estimated cost after the conversion process is lower than an estimated cost before the conversion process as a result of estimating the difference in cost before and after the conversion process.

Then the processing section 222 can perform the process of deleting a pack/unpack code from the binary code for a part not subjected to the conversion process as a result of a calculation of the estimation of the cost difference.

The processing section 222 determines the difference in cost before and after the conversion process according to an addition equation:

cost difference=(a difference in cost of accessing a variable by an instruction between a case in which the variable is a zoned decimal type variable and a case in which the variable is a binary type variable, multiplied by the frequency of execution of the instruction)

+(a cost of conversion into the binary type variable multiplied by the frequency of execution of entering each detected area)

+(a cost of conversion into the zoned decimal type variable multiplied by the frequency of execution of exiting from each detected area)

+(a cost of a residue calculation instruction for digit alignment multiplied by the frequency of execution of the residue calculation instruction).

In the above equation, “the frequency of execution of the instruction” in “a cost difference between the cost of accessing the zoned decimal type variable by an instruction and the cost of accessing the binary type variable by the instruction, multiplied by the frequency of execution of the instruction” may be the frequency of execution for either the zoned decimal type variable or the binary type variable. This is because both of the variables access the same location, resulting in the same frequency of execution.

In order to delete a pack/unpack code from the binary code, the processing section 222 performs the following process (c1) to (c2):

(c1) for a variable for which a write operation is performed in the area not including an instruction that can cause a side effect, the processing section 222 deletes, from the binary code, a code other than the first and last type conversion instructions among pack/unpack codes for a zoned decimal type variable in the area not including an instruction that can cause a side effect; and

(c2) for a variable for which a write operation is not performed in the area not including an instruction that can cause a side effect, the processing section 222 deletes, from the binary code, a code other than the first type conversion instruction among pack/unpack codes for a zoned decimal type variable in the area not including an instruction that can cause a side effect.

Further, (c3) when deleting the code other than the type conversion instruction(s) in (c1) and/or (c2), the processing section 222 deletes a sign processing code associated with the deleted code from the binary code.

After the processing section 222 performs any one of the processes of converting a zoned decimal type variable into a binary type variable, the process of deleting, from the binary code, a pack/unpack code such that a converted result does not change even if the pack/unpack code is deleted, and the process of a combination of these processes, the deletion section 223 deletes a code of a residue calculation instruction for digit alignment from the binary code.

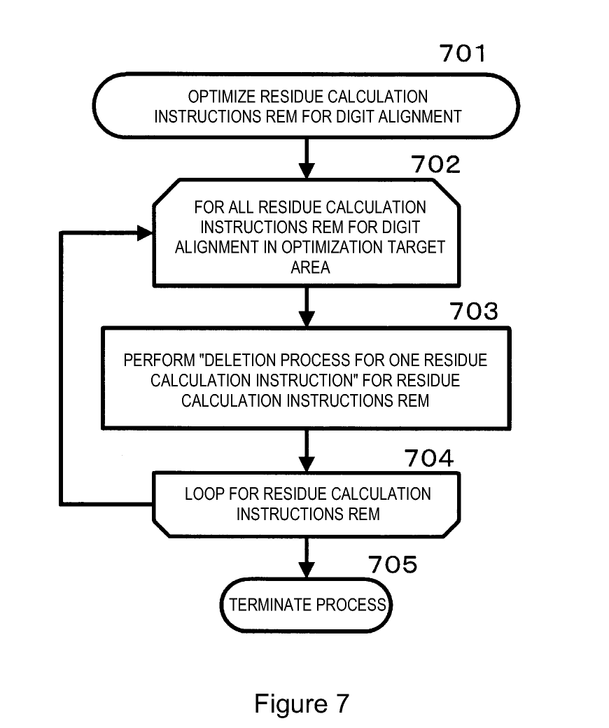

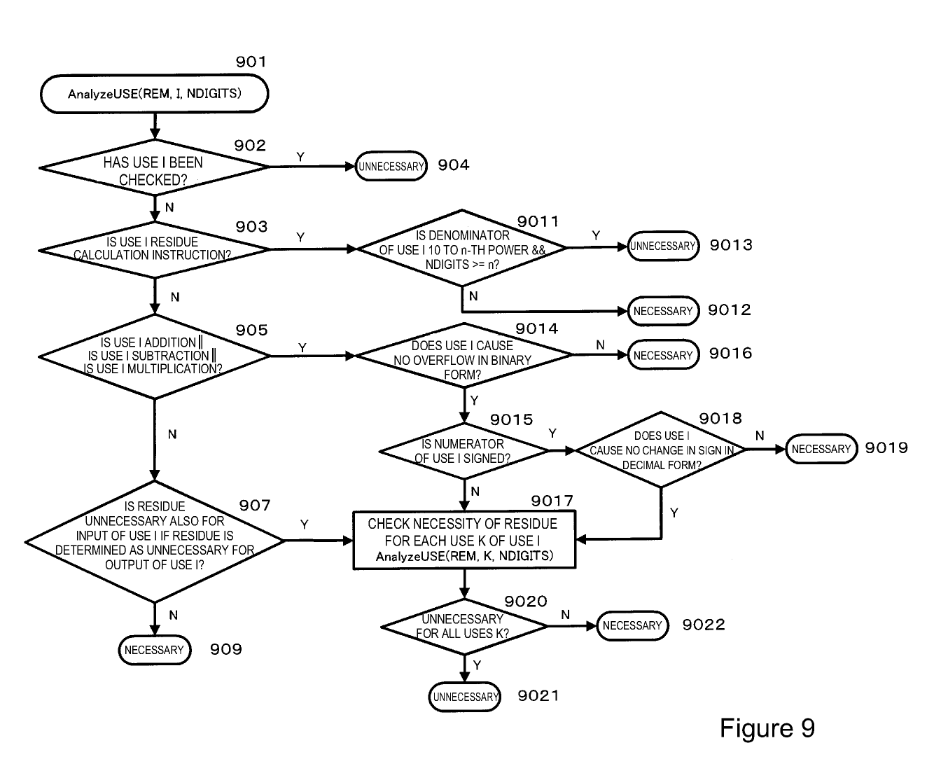

In deleting a code of a residue calculation instruction for digit alignment, the deletion section 223 performs the following process (A) to (B) (see FIGS. 7 to 11 below, in particular FIG. 9):

(A) if the variable is an n1-digit variable and further if a condition n1≧n2 is satisfied for a residue calculation instruction for making the variable an n2-digit variable, the deletion section 223 deletes a code of a residue calculation instruction for making the variable an n1-digit variable;

(B) if (A) does not apply, the deletion section 223 performs the following process (a) to (b) depending on whether the variable is unsigned or signed,
(a) if the variable is unsigned (as determined in step 9015 in FIG. 9 below),
   (a1) if operations of addition, multiplication, or subtraction are continuous in the detected area (as determined in step 905 in FIG. 9) and only if the range of operations in which it can be guaranteed that no binary calculation overflow occurs (as determined in step 9014 in FIG. 9) is known at the time of compilation, the deletion section 223 deletes, from the binary code, a code of a residue calculation instruction other than a code of the last residue calculation instruction among the guaranteed continuous operations;
   (a2) if (a1) does not apply, the deletion section 223 guarantees that the number of digits is correct before an operation that does not satisfy (a1);
(b) if the variable is signed (as determined in step 9015 in FIG. 9 below),
   (b1) if operations of addition, multiplication, or subtraction are continuous in the detected area (as determined in step 905 in FIG. 9) and only if the range of operations in which it can be guaranteed that the sign does not change during the continuous operations (as determined in step 9018 in FIG. 9) and that no binary calculation overflow occurs (as determined in step 9014 in FIG. 9) is known at the time of compilation, the deletion section 223 deletes, from the binary code, a code of a residue calculation instruction other than a code of the last residue calculation instruction among the guaranteed continuous operations; and
   (b2) if (b1) does not apply, the deletion section 223 guarantees that the number of digits is correct before an operation that does not satisfy (b1).

In (a2), guaranteeing that the number of digits is correct before the operation that does not satisfy the condition (a1) includes inserting a code of a residue calculation instruction that makes the number of digits correct before the operation into the binary code, or doing nothing if the correct number of digits is guaranteed without inserting a code of a residue calculation instruction that makes the number of digits correct before the operation into the binary code. For example, if the number of digits is n1, inserting the code of the residue calculation instruction that makes the number of digits correct before the operation into the binary code is inserting a residue calculation instruction that makes the number of digits n1 into the binary code.

Also in (b2), guaranteeing that the number of digits is correct before the operation that does not satisfy the condition (b1) includes inserting a code of a residue calculation instruction that makes the number of digits correct before the operation into the binary code, or doing nothing if the correct number of digits is guaranteed without inserting a code of a residue calculation instruction that makes the number of digits correct before the operation into the binary code. For example, if the number of digits is n1, inserting the code of the residue calculation instruction that makes the number of digits correct before the operation into the binary code is inserting a residue calculation instruction that makes the number of digits n1 into the binary code.

The deletion section 223 guarantees in (a2) by generating a code of a residue calculation instruction for guaranteeing that the number of digits is correct before the operation that does not satisfy (a1), and by inserting the generated code of the residue calculation instruction into the binary code.

The deletion section 223 guarantees in (b2) by generating a code of a residue calculation instruction for guaranteeing that the number of digits is correct before the operation that does not satisfy (b1), and by inserting the generated code of the residue calculation instruction into the binary code.

The reduction section 224 reduces the operator strength of each remaining residue calculation instruction in the binary code. The reduction section 224 reduces the operator strength after the deletion section 223 deletes the code of the residue calculation instruction for digit alignment from the binary code.

The reduction section 224 reduces the operator strength by replacing the residue calculation operation with an equation below. That is, the residue calculation operation is replaced with:

result=(numerator<denominator && numerator>=0)?numerator:(numerator % denominator).

FIG. 3A shows flowcharts of the entire process of optimizing binary code in a language having access to a zoned decimal type variable according to an embodiment of the present invention.

The optimization process may be divided into three flowcharts in the following aspects.

A. In an optimization process starting from step 301 (hereinafter referred to as an optimization process 301), the optimization includes the process of converting a zoned decimal type variable into a binary type variable (step 303).

B. In an optimization process starting from step 311 (hereinafter referred to as an optimization process 311), the optimization includes the process of deleting, from the binary code, a pack/unpack code such that a converted result does not change even if the pack/unpack code is deleted (step 314). “A converted result does not change” means that the converted result is guaranteed.

C. In an optimization process starting from step 321 (hereinafter referred to as an optimization process 321), the optimization includes a combination of the process of step 303 in the optimization process 301 (step 323) and the process of step 314 in the optimization process 311 (step 324).

The optimization processes 301, 311, and 321 will be described below.

### A. Optimization Process 301

In step 301, the computer 201 receives binary code from the storage unit 202. Alternatively, the computer 201 receives binary code converted with a COBOL compiler from the conversion unit 214. The computer 201 passes the received binary code to the optimization unit 215.

In step 302, the detection section 221 in the optimization unit 215 detects, for each variable in the binary code, an area including access to a zoned decimal type variable and not including an instruction that can cause a side effect (hereinafter also referred to as an optimization target area). The area not including an instruction that can cause a side effect may be rephrased as an area not including an instruction that leads to a side effect. The detection section 221 detects the optimization target area through flowcharts in FIGS. 4 to 6 below.

For example, it is assumed that both of optimization target areas A and B in the binary code include access to a zoned decimal type variable v, but only the area A is determined as an area not including an instruction that can cause a side effect. In this case, the zoned decimal type variable only in the area A is converted into a binary type variable. That is, the conversion into a binary type variable is performed only for the area A and not for the area B. Here, since the variable v is stored in one memory area, the processing section 222, in order to perform the conversion into a binary type variable only for the area A, reads and copies the variable v into a working area and converts the copy of the variable v into a binary type variable. The working area is provided in the memory.

In an embodiment of the present invention, an instruction that can cause a side effect is an instruction that can cause process inconsistency as a result of type conversion of a zoned decimal type variable into a binary type variable, or an instruction that can cause process inconsistency as a result of deleting a pack/unpack code.

In an embodiment of the present invention, an instruction that can cause a side effect includes at least one of: an instruction that executes an instruction out of a compilation scope; an instruction that can cause an exception observable (or visible) from an application; and an instruction that changes a base address register or an index register of the variable.

An instruction that executes an instruction out of a compilation scope is, for example, a call instruction or an indirect branch instruction.

An instruction that can cause an exception observable from an application is, for example, an instruction that can cause an exception such that it is known at the time of compilation that the application does not capture and process the exception on the occurrence of the exception. An “exception” may be what is visible from an application. A typical instruction that can cause an exception is an instruction related to an instruction for memory access.

For an instruction that can cause an exception observed by an application, the exception can be ignored by using a transactional memory technique described in the specification of U.S. Pat. No. 7,865,885 to repeat the execution from a certain point on the occurrence of the exception. This allows the optimization technique according to the present invention to be more efficiently applied.

Also, for an instruction that can cause an exception observed by an application, the cost of detecting an instruction that can cause a side effect can be reduced by utilizing the fact that a memory access to working storage never causes an exception. It can be detected that an access to working storage is made, for example at the time of compilation. Whether an access to working storage is made can be analyzed on the basis whether a particular register is used as a base register if a particular COBOL initialization pattern is detected. This is based on the fact that an access to a working storage section does not actually cause an exception if a COBOL initialization routine is correctly executed.

An instruction that changes a base address register or an index register is, although not limited to, a load instruction, an operation instruction, or a register-to-register copy instruction, for example.

In step 303, the processing section 222 in the optimization unit 215 performs the process of converting a zoned decimal type variable into a binary type variable in the optimization target area detected in step 302. The conversion process may include estimating a cost difference before and after the conversion process and performing the conversion process if an estimated cost after the conversion process is lower than an estimated cost before the conversion process. The cost difference before and after the conversion process can be determined according to an equation:

cost difference=(a difference in cost of accessing a variable (including a variable in a temporary calculation area) by an instruction between a case in which the variable is a zoned decimal type variable and a case in which the variable is a binary type variable, multiplied by the frequency of execution of the instruction)

+(a cost of converting into the binary type variable multiplied by the frequency of execution of entering each detected area)

+(a cost of converting into the zoned decimal type variable multiplied by the frequency of execution of exiting from each detected area)

+(a cost of a residue calculation instruction for digit alignment multiplied by the frequency of execution of the residue calculation instruction).

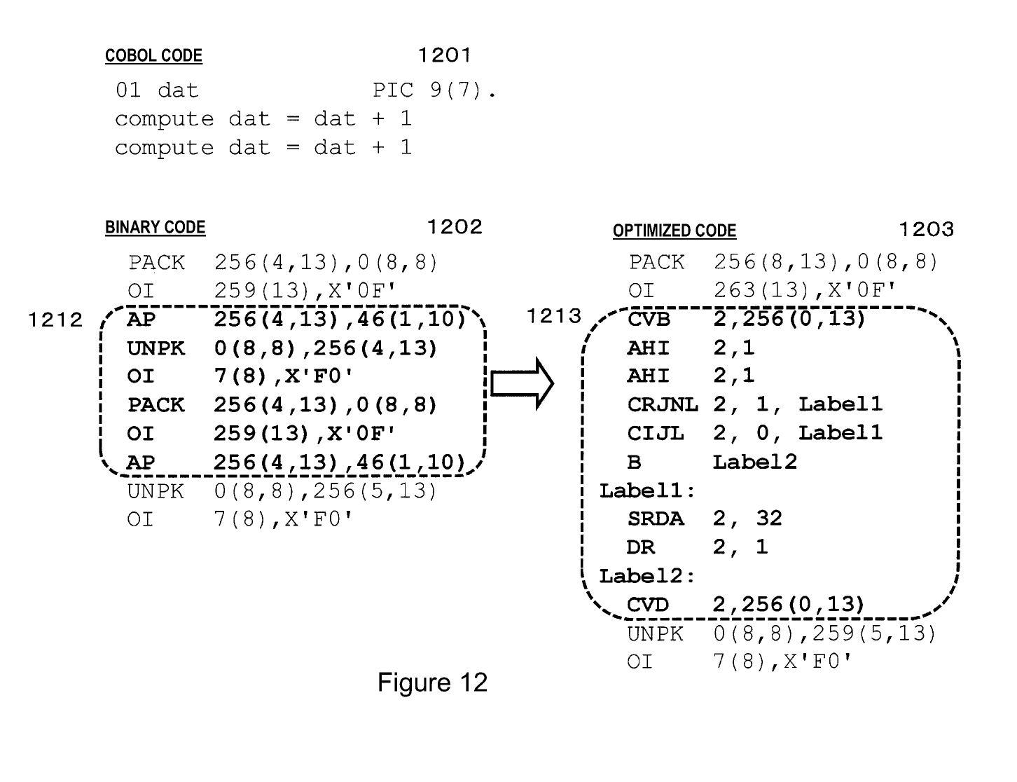

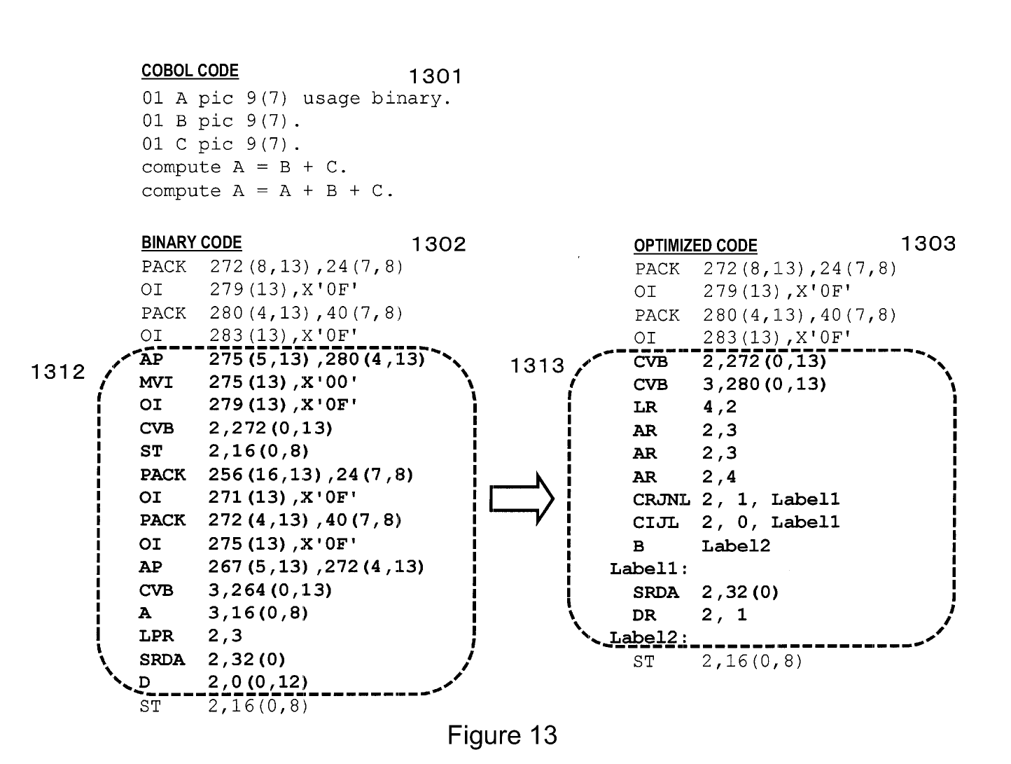

In step 305, the deletion section 223 in the optimization unit 215 optimizes codes of residue calculation instructions for digit alignment after step 303. Optimizing codes of residue calculation instructions includes deleting codes of residue calculation instructions for digit alignment from the binary code and optionally reducing the operator strength of each remaining residue calculation instruction in the binary code. The reduction of the operator strength may be performed in step 306 independently from step 305. The deletion section 223 deletes the codes of the residue calculation instructions through flowcharts shown in FIGS. 7 to 10 below. An example of deleting the codes of the residue calculation instructions according to an embodiment of the present invention is shown in FIGS. 12 and 13 below. In step 305, the deletion section 223 can collectively delete a number of residue calculations.

In the case of COBOL, specifications of the residue for digit alignment are specified by the COBOL specifications. The residue for digit alignment results in a value from 0 to 999 if the variable is a three-digit unsigned variable. In binary operation code generated by a COBOL compiler, this digit alignment is performed for each operation. In an embodiment of the present invention, where the residue for digit alignment is performed is identified through flowcharts shown in FIGS. 7 to 10.

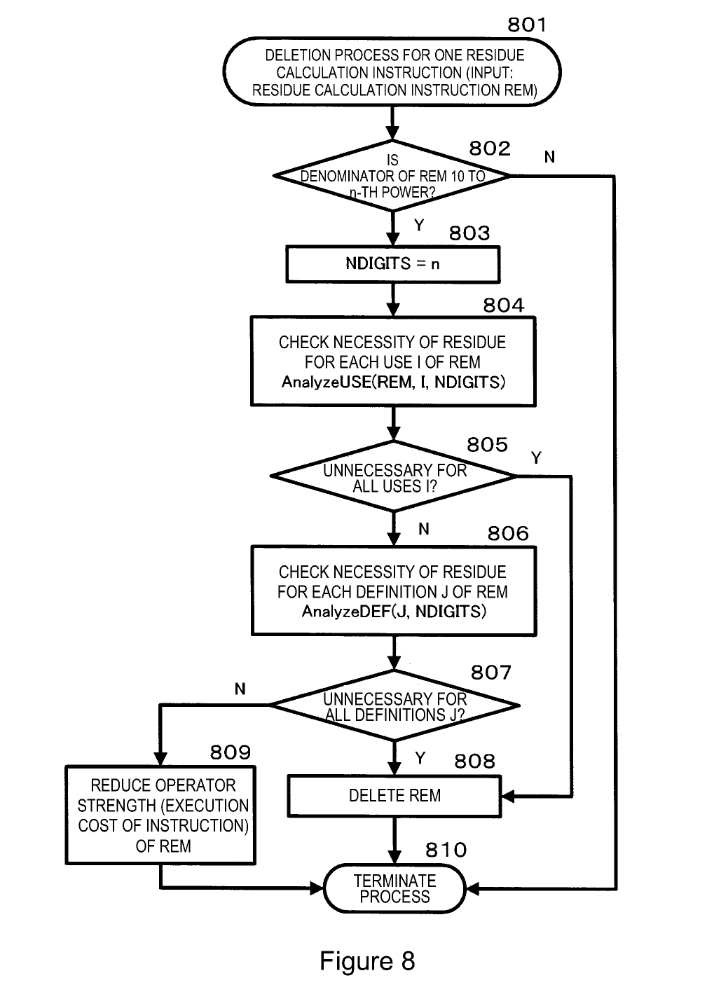

In step 306, the reduction section 224 in the optimization unit 215 reduces the operator strength of each remaining residue calculation instruction in the binary code after step 305. As shown in FIG. 8, the reduction section 224 can reduce the operator strength of each remaining residue calculation instruction in the binary code in the process of step 305.

In step 307, the computer 201 terminates the process of optimizing the binary code.

### B. Optimization Process 311

Steps 311 to 312 and steps 315 to 317 correspond to steps 301 to 302 and steps 305 to 307 in the optimization process 301, respectively.

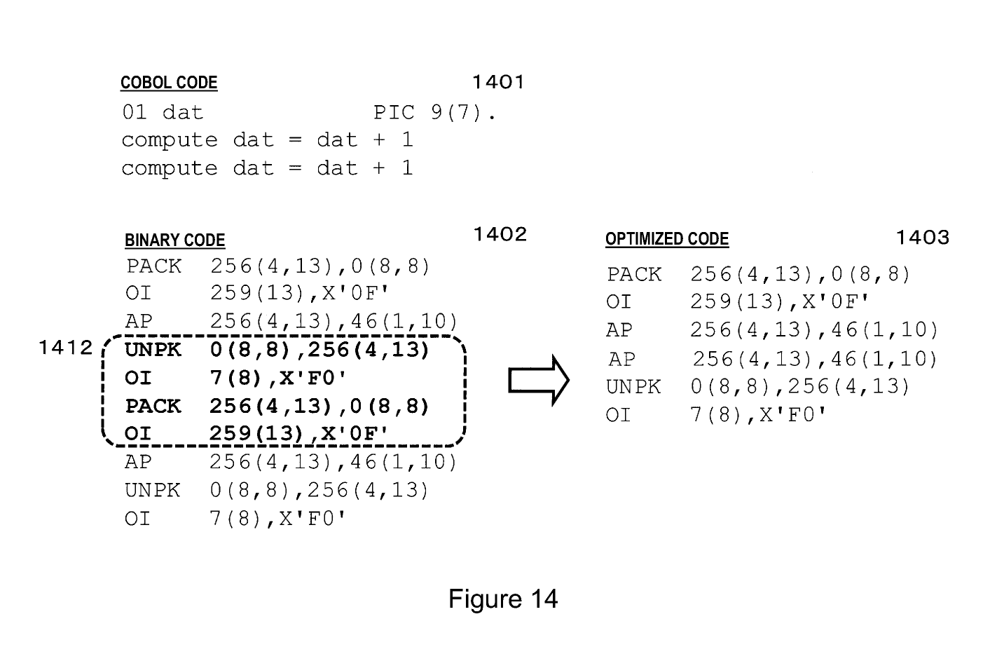

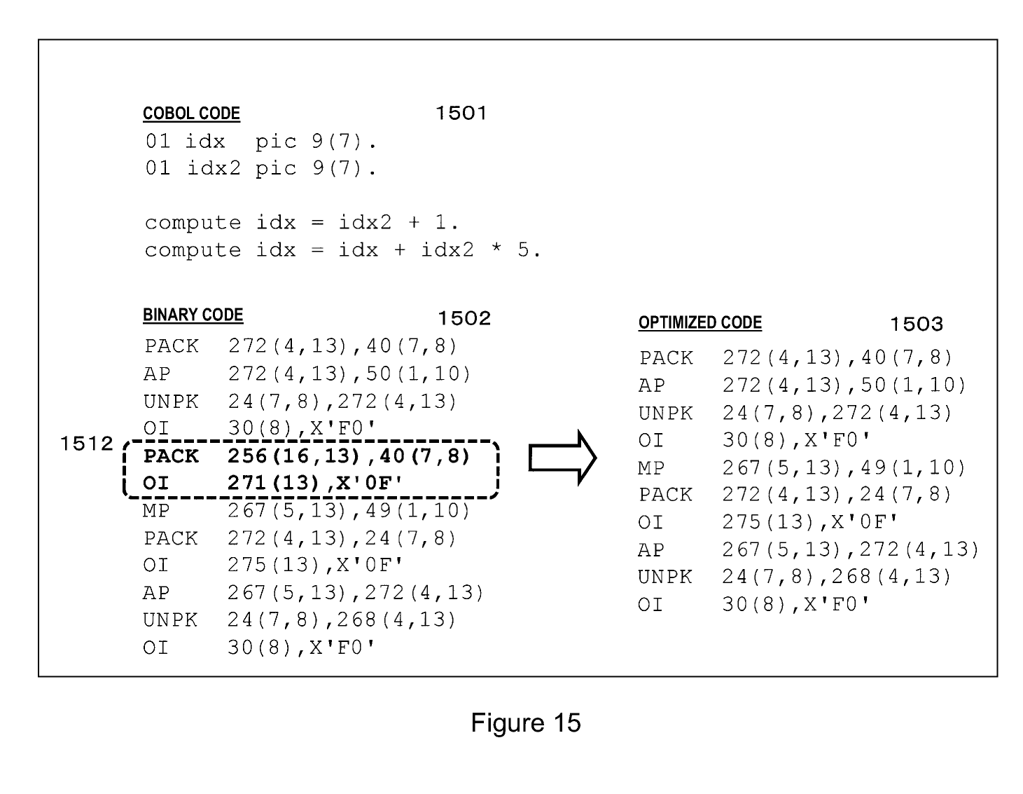

In step 314, the processing section 222 performs the process of deleting a pack/unpack code in the optimization target area detected in step 312. The pack/unpack code to be deleted is a pack/unpack code in the optimization target area detected in step 312 such that a converted result does not change even if the pack/unpack code is deleted. An example of deleting the pack/unpack code according to an embodiment of the present invention is shown in FIGS. 14 and 15 below.

The process of deleting the pack/unpack code from the binary code is performed through the following process, for example.

The processing section 222 determines whether the variable is a variable for which a write operation is performed in the area not including an instruction that can cause a side effect (also referred to as variable that is updated) or a variable for which a write operation is not performed in the area not including an instruction that can cause a side effect (also referred to as a variable that is not updated).

If the variable is a variable that is updated, the processing section 222 deletes, from the binary code, a code other than the first and last type conversion instructions among pack/unpack codes for the zoned decimal type variable in the area not including an instruction that can cause a side effect. In other words, since the first and last type conversion instructions are not deleted, the first and last type conversion instructions are executed in execution of the optimized binary code. The processing section 222 can also delete a sign processing code associated with the deleted codes from the binary code.

If the variable is a variable that is not updated, the processing section 222 deletes, from the binary code, a code other than the first type conversion instruction among pack/unpack codes for the zoned decimal type variable in the area not including an instruction that can cause a side effect. In other words, since the first type conversion instruction is not deleted, the first type conversion instruction is executed in execution of the optimized binary code. The processing section 222 can also delete a sign processing code associated with the deleted code from the binary code. Exemplary sign processing codes associated with deleted codes are codes of “OI” written in a code portion 1412 in binary code 1402 in FIG. 14 and in a code portion 1512 in binary code 1502 in FIG. 15.

In deletion of the pack/unpack code, the codes of the first and last type conversion instructions are detected as follows. The processing section 222 determines that the block is an intermediate block if the KILL(B) is φ and if the IN(B) and the OUT(B) contain a variable v, and that a block or blocks not satisfying this condition include(s) the code(s) of the first and/or last type conversion instruction(s).

### C. Optimization Process 321

Steps 321 to 322, step 323, and steps 325 to 327 correspond to steps 301 to 302, step 303, and steps 305 to 307 in the optimization process 301, respectively.

Step 324 corresponds to step 314 in the optimization process 311 except for the following point:

In step 324, the processing section 222 performs the process of deleting a pack/unpack code for a part not subjected to the conversion process of step 323 (e.g., a part not subjected to the conversion process as a result of the cost calculation) in the optimization target area detected in step 322.

The processing section 222 can perform the process of step 324 before the process of step 323. In this case, in step 323, the processing section 222 performs the process of converting a zoned decimal type variable into a binary type variable for a part not subjected to the process of step 324 in the optimization target area detected in step 322. However, the compilation time in the case of performing the process of step 324 before the process of step 323 is longer than that in the case of performing the process of step 324 after the process of step 323.

The above-described optimization process may be performed by a compiler that implements the optimization technique according to the present invention, for example when COBOL source code is statically or dynamically compiled. The above-described optimization process can also be performed by an application that implements the optimization technique before or while COBOL binary code is executed.

FIG. 3B shows a flowchart of the entire process of optimizing binary code in a language having access to a zoned decimal type variable in an embodiment of the present invention.

In step 331, the computer 201 receives binary code from the storage unit 202. Alternatively, the computer 201) receives binary code converted with a COBOL compiler from the conversion unit (214).

In step 332, the deletion section 223 optimizes codes of residue calculation instructions for digit alignment. The optimization of the codes of the residue calculation instructions corresponds to steps 305, 315, and 325 in FIG. 3A.

In step 333, for each variable in the binary code with the codes of the residue calculation instructions optimized, the detection section 221 detects an area (optimization target area) including access to a zoned decimal type variable and not including an instruction that can cause a side effect. The detection of the optimization target area corresponds to steps 302, 312, and 322 in FIG. 3A.

In step 334, the processing section 222 performs the process of converting a zoned decimal type variable into a binary type variable in the optimization target area detected in step 333. The processing of converting the zoned decimal type variable into the binary type variable corresponds to steps 303 and 323 in FIG. 3A.

In step 335, the processing section 222 performs the process of deleting a pack/unpack code in the optimization target area detected in step 333. The processing section 222 can perform the process of step 335 before the process of step 334. In this case, in step 334, the processing section 222 performs the process of converting the zoned decimal type variable into the binary type variable for a part not subjected to the process of step 335 in the optimization target area detected in step 333. The process of deleting the pack/unpack code corresponds to steps 314 and 324 in FIG. 3A.

In step 336, the reduction section 224 reduces the operator strength of each remaining residue calculation instruction in the binary code after step 335. As shown in FIG. 8, the reduction section 224 can reduce the operator strength of each remaining residue calculation instruction in the binary code in the process of step 332 or immediately after step 332. The reduction of the operator strength corresponds to steps 306, 316, and 326 in FIG. 3A.

In step 337, the computer 201 terminates the process of optimizing the binary code.

FIG. 4 shows a flowchart of the process of detecting an area including access to a zoned decimal type variable and not including an instruction that can cause a side effect (steps 302, 312, and 322) in the optimization process shown in FIG. 3A.

In step 401, the detection section 221 starts the process of detecting an area including access to a zoned decimal type variable and not including an instruction that can cause a side effect.

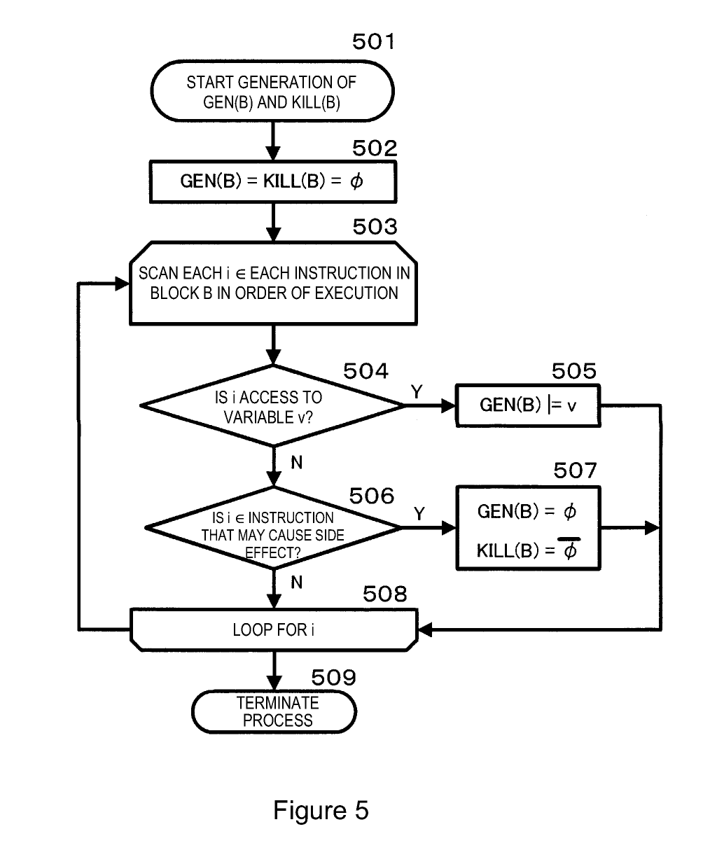

In step 402, the detection section 221 generates the GEN(B) and the KILL(B). The GEN(B) is a set of variables accessed after an instruction that can cause a side effect in each block B of the binary code. The KILL(B) is a set of all variables in each block B if at least one instruction that can cause a side effect exists (whereas it is an empty set if an instruction that can cause a side effect does not exist). The GEN(B) and the KILL(B) are input data for data flow equations used in data flow analysis shown in step 403 below. Generation of the GEN(B) and the KILL(B) will be described with reference to a flowchart shown in FIG. 5 below.

In step 403, the detection section 221 uses the data flow equations shown in FIG. 4 to determine the IN(B) by applying the GEN(B) and the KILL(B) generated in step 402 to the data flow equations.

The IN(B) is a set of variables at the beginning of each block B, the variables being accessed after an instruction that can cause a side effect. An area not including an instruction that can cause a side effect is detected from the binary code on the basis of the IN(B) in steps 404 and 405 below.

In the data flow equations, the OUT(N) in the equation for determining the IN(B) is a set of variables at the end of a block N located immediately before the block B being processed with the data flow equations, the variables being accessed after an instruction that can cause a side effect. The block N is any one or plurality of blocks processed immediately before the block B. The block N is often a plurality of blocks.

In the data flow equations, NεPred(B) in the equation for determining the IN(B) means that the process is performed for the block N immediately before the block B being processed.

In step 404, the detection section 221 sets, for each instruction i in each block B, the content of the VSET set information as additional information. For example, the additional information is set for each instruction i from the set information of the VSET, which is a working area. The VSET is a working area in the memory, for example. The additional information is information for identifying the “area including access to a zoned decimal type variable v and not including an instruction that can cause a side effect,” in the binary code read into the memory.

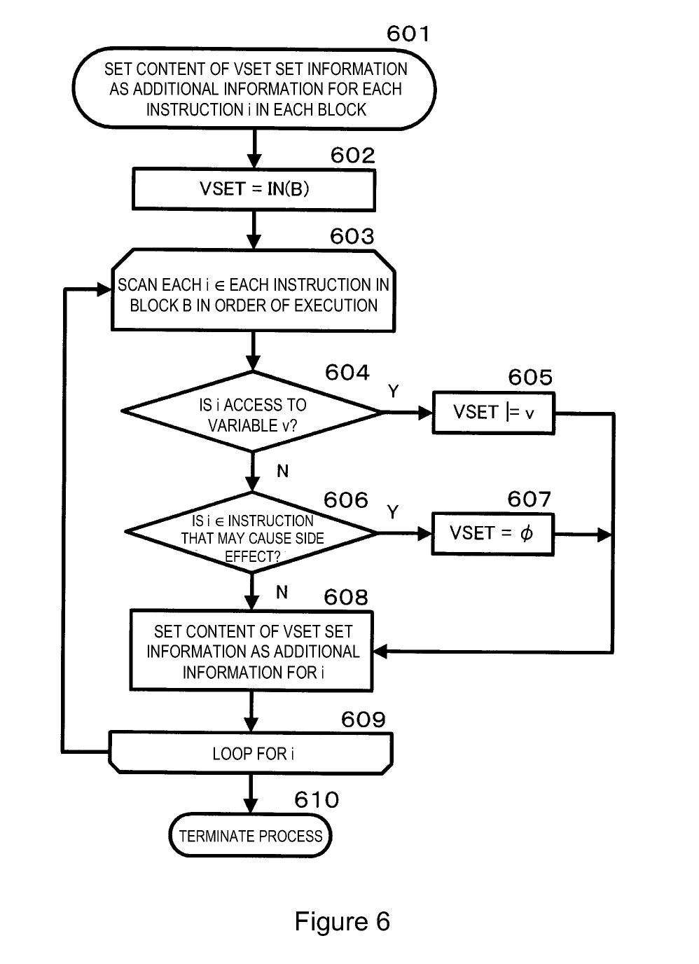

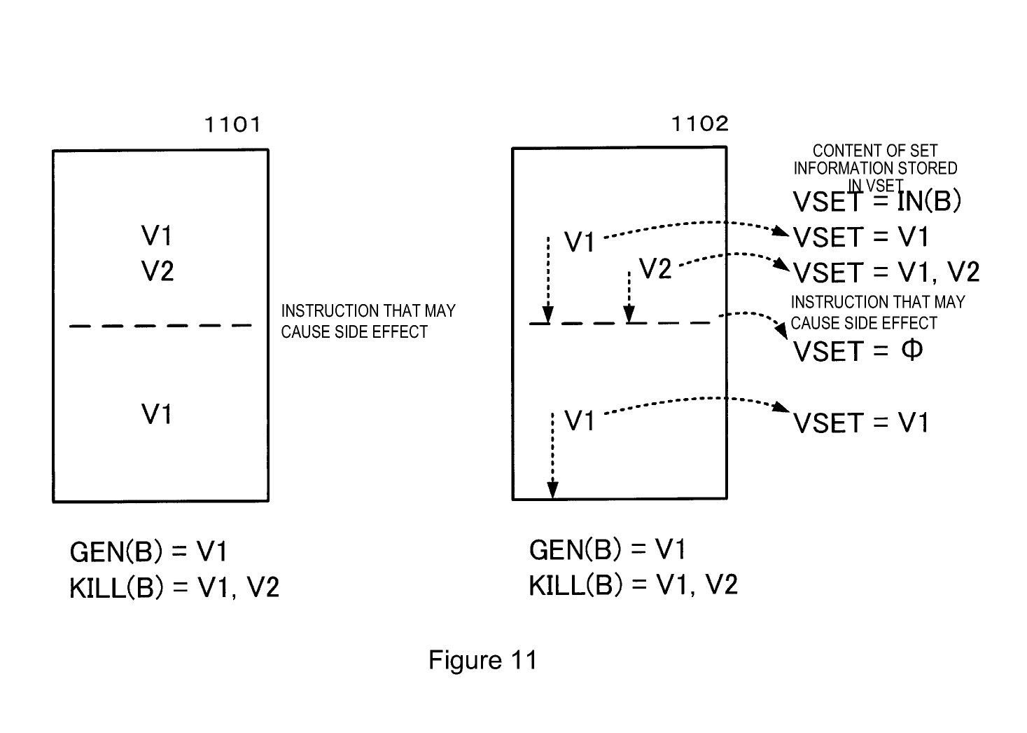

FIG. 6 below shows a flowchart for setting the content of the VSET set information as the additional information for each instruction i in each block. FIG. 11 below shows an example of the content of the set information, for example IN(B); V1; V1, V2; φ; and V1, from the top, in a block 1102.

In step 405, with respect to the additional information that has been set for each instruction i in step 404, the detection section 221 regards an area in which each variable is continuous as an area not including an instruction that can cause a side effect for the variable.

In step 406, the detection section 221 terminates the process of detecting the area including access to a zoned decimal type variable and not including an instruction that can cause a side effect.

The process of step 404 may be written as a pseudo-code as follows.

VSET = IN(B);
for (scan each i ∈ each instruction i in the block B in the order of
execution) {
if (i is an access to v){
VSET |= v;
} else if (i ∈ instruction that may cause a side effect){
VSET = φ;
}

set the content of the VSET set information as additional
information for i;

}

FIG. 5 shows a flowchart of the process of generating the GEN(B) and the KILL(B) (step 402) in the detection process shown in FIG. 4.

In step 501, the detection section 221 starts the process of generating the GEN(B) and KILL(B).

In step 502, the detection section 221 initializes the GEN(B) and the KILL(B) as empty sets (φ).

In step 503, the detection section 221 scans each instruction i in the block B in the order of execution.

In step 504, the detection section 221 determines whether the instruction i is an access to the variable v. If the instruction i is an access to the variable v, the detection section 221 proceeds to step 505. If the instruction i is not an access to the variable v, the detection section 221 proceeds to step 506.

In step 505, the detection section 221 determines the GEN(B)|=v from the instruction i determined in step 504.

In step 506, the detection section 221 determines whether the instruction i is an instruction that can cause a side effect. If the instruction i is an instruction that can cause a side effect, the detection section 221 proceeds to step 507. If the instruction i is not an instruction that can cause a side effect, the detection section 221 proceeds to step 508.

In step 507, the detection section 221 determines a complement set of the KILL(B)=φ from the instruction i determined in step 506. The detection section 221 also initializes the GEN(B) as an empty set (φ).

In step 508, for each instruction i in each block B, the detection section 221 repeats steps 503 to 507 in the order of execution. In response to completion of the process of steps 503 to 507 for all the instructions i, the detection section 221 proceeds to step 509.

In step 509, the detection section 221 terminates the process of generating the GEN(B) and the KILL(B).

FIG. 6 shows a flowchart of the process of setting the content of the VSET set information as additional information for the instruction i in each block B (step 404) in the detection process shown in FIG. 4.

In step 601, the detection section 221 starts the process of setting the content of the set information of the VSET, which is a working area, as additional information for the instruction i in each block B.

In step 602, the detection section 221 copies the content of the IN(B) into the VSET.

In step 603, the detection section 221 scans each instruction i in the block B in the order of execution.

In step 604, the detection section 221 determines whether the instruction i is an access to the variable v. If the instruction i is an access to the variable v, the detection section 221 proceeds to step 605. If the instruction i is not an access to the variable v, the detection section 221 proceeds to step 606.

In step 605, the detection section 221 determines the GEN(B)|=v from the instruction i determined in step 604.

In step 606, the detection section 221 determines whether the instruction i is an instruction that can cause a side effect. If the instruction i is an instruction that can cause a side effect, the detection section 221 proceeds to step 607. If the instruction i is not an instruction that can cause a side effect, the detection section 221 proceeds to step 608.

In step 607, the detection section 221 initializes the VSET as an empty set (φ).

In step 608, the detection section 221 sets the VSET set information as an additional information for the instruction i. Depending on whether step 604 results in Yes, or step 606 results in Yes, or step 606 results in No, the VSET has different set information added thereto, or initialized, or unmodified, respectively. An example of the content of the VSET set information is shown in FIG. 11 below.

In step 609, the detection section 221 repeats steps 603 to 608 for each instruction i in each block B in the order of execution. In response to completion of the process of steps 603 to 608 for all the instructions i, the detection section 221 proceeds to step 610.

In step 610, the detection section 221 terminates the process of setting the content of the VSET set information as the additional information for each instruction in each block B.

FIG. 7 shows a flowchart of the process of optimizing the residue calculation instruction for digit alignment (steps 305, 315, and 325) in the optimization process shown in FIG. 3A.

In step 701, the deletion section 223 starts the process of optimizing the residue calculation instructions REM for digit alignment.

In step 702, the deletion section 223 starts a loop for performing the deletion process of step 703 for all residue calculation instructions REM for digit alignment in the optimization target area.

In step 703, the deletion unit 223 performs the deletion process for one residue calculation instruction for the residue calculation instructions REM. Details of the deletion process for one residue calculation instruction will be described in FIGS. 8 to 10 below.

In step 704, the deletion section 223 performs the deletion process for unprocessed residue calculation instructions. In response to completion of the process of step 703 for all the residue calculation instructions, the deletion section 223 proceeds to step 705.

In step 705, the deletion section 223 terminates the process of optimizing the residue calculation instructions REM for digit alignment.

FIG. 8 shows a flowchart of the process of performing the “deletion process for one residue calculation instruction” in the residue calculation instructions REM (step 703) in the process of optimizing the residue calculation instructions shown in FIG. 7.

A residue calculation instruction can be deleted on the condition that no problems occur even if the number of digits is incorrect, or that no problems occur because the number of digits is already correct. It is determined that no problems occur even if the number of digits is incorrect according to AnalyzeUSE(REM, I, NDIGITS) to be described below. It is determined that no problems occur because the number of digits is already correct according to AnalyzeDEF(J, NDIGITS) to be described below.

In step 801, the deletion section 223 starts the deletion process for one residue calculation instruction. Input data is a residue calculation instruction REM.

In step 802, the deletion section 223 determines whether the denominator of the residue calculation instruction REM is 10 to the n-th power. If the denominator of the residue calculation instruction is 10 to the n-th power, the deletion section 223 proceeds to step 803. If the denominator of the residue calculation instruction is not 10 to the n-th power, the deletion section 223 proceeds to step 810 to terminate the deletion process for one residue calculation instruction.

In step 803, the deletion section 223 substitutes n for a variable NDIGITS.

In step 804, for each use I of the residue calculation instruction REM, the deletion section 223 determines the necessity of the residue calculation instruction according to AnalyzeUSE(REM, I, NDIGITS). AnalyzeUSE(REM, I, NDIGITS) will be described in a flowchart shown in FIG. 9 below.

In step 805, the deletion section 223 determines whether the residue calculation instruction is unnecessary for all uses I. If the residue calculation instruction is unnecessary for all the uses I, the deletion section 223 proceeds to step 808 to delete the REM. If the residue calculation instruction is not unnecessary for all the uses I, the deletion section 223 proceeds to step 806.

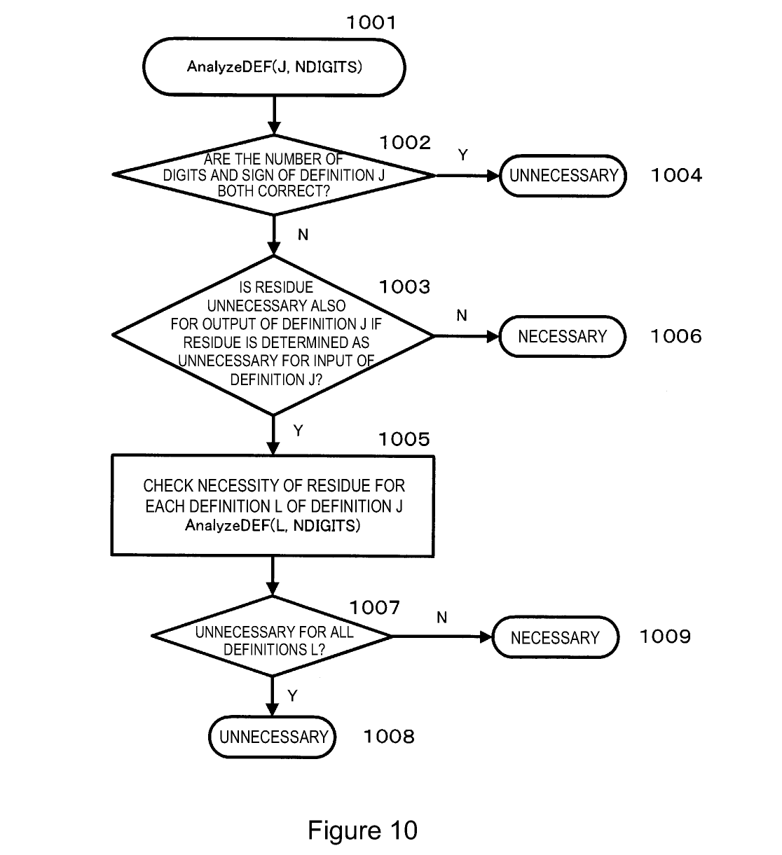

In step 806, for each definition J of the residue calculation instruction REM, the deletion section 223 determines the necessity of the residue calculation instruction according to AnalyzeDEF(J, NDIGITS). AnalyzeDEF(J, NDIGITS) will be described in a flowchart shown in FIG. 10 below.

In step 807, the deletion section 223 determines whether the residue calculation instruction is unnecessary for all definitions J. If the residue calculation instruction is unnecessary for all the definitions J, the deletion section 223 proceeds to step 808 to delete the REM. If the residue calculation instruction is not unnecessary for all the uses J, the deletion section 223 proceeds to step 809. Although the deletion section 223 proceeds to step 809 if the residue calculation instruction is not unnecessary for all the uses J in FIG. 8, the deletion section 223 may bypass step 809 and proceeds to step 810 to terminate the deletion process for one residue calculation instruction.

In step 808, the deletion section 223 deletes the residue calculation instruction REM in response to the determination that the residue calculation instruction is unnecessary for all the uses I in step 805 or that the residue calculation instruction is unnecessary for all the definitions J in step 807.

In step 809, the deletion section 223 requests the reduction section 224 to reduce the operator strength (the execution cost of the instruction) of the REM. The reduction section 224 reduces the operator strength by replacing the residue calculation operation with result=(numerator<denominator && numerator>=0)? numerator: (numerator % denominator). The replacement may be performed for each remaining residue calculation instruction undeleted in the binary code, not limited to residue calculation operations in the optimization target area. The reduction section 224 returns processing to the deletion section 223 after reducing the operator strength. In response to completion of the operator strength reduction by the reduction section 224, the deletion section proceeds to step 810.

In step 810, the deletion section 223 terminates the deletion process for one residue calculation instruction.

FIG. 9 shows a flowchart of the process AnalyzeUSE(REM, I, NDIGITS) for checking whether a residue is necessary or not for each use I of the residue calculation instruction REM (step 804) in the process of optimizing the residue calculation instruction shown in FIG. 8.

In step 901, the deletion section 223 starts the process of determining whether the use I is necessary or not according to the process AnalyzeUSE(REM, I, NDIGITS) for checking whether the residue is necessary or not for each use I of the REM.

In step 902, the deletion section 223 determines whether the use I has been checked. If the use I has not been checked, the deletion section 223 proceeds to step 903. If the use I has been checked, the deletion section 223 determines that the use I is unnecessary (904).

In step 903, the deletion section 223 determines whether the use I is a residue calculation instruction. If the use I is a residue calculation instruction, the deletion section 223 proceeds to step 9011. If the use I is not a residue calculation instruction, the deletion section 223 proceeds to step 905.

In step 905, the deletion section 223 determines whether the use I is any of addition, subtraction, or multiplication. If the use I is none of addition, subtraction, or multiplication, the deletion section 223 proceeds to step 907. If the use I is any of addition, subtraction, or multiplication, the deletion section 223 proceeds to step 9014.

In step 907, the deletion section 223 determines whether the residue is unnecessary also for input of the use I if the residue is determined as unnecessary for output of the use I. If the residue is unnecessary also for input of the use I, the deletion section 223 proceeds to step 9017. If the residue is not unnecessary also for input of the use I, the deletion section 223 proceeds to step 909 to terminate the process AnalyzeUSE(REM, I, NDIGITS) for checking whether the residue is necessary or not for each use I of the residue calculation instruction REM.

In step 9011, the deletion section 223 determines whether the denominator of the use I is 10 to the n-th power && NDIGITS>=n. If the denominator of the use I is 10 to the n-th power && NDIGITS>=n, the deletion section 223 determines that the use I is unnecessary (9013). If the denominator of the use I is not 10 to the n-th power && NDIGITS>=n, the deletion section 223 determines that the use I is necessary (9012). If NDIGITS is neither equal to nor larger than n, the residue calculation instruction cannot be deleted because it is necessary (9012). If NDIGITS >=n, the residue calculation instruction can be deleted because it is unnecessary (9013). In NDIGITS>=n, NDIGITS corresponds to the n1 digits, and n corresponds to n2 digits. Therefore, if there are a residue calculation instruction to round a variable to n1 digits and a residue calculation instruction to further round the variable to n2 digits (n2≦n1), it means deleting the residue calculation instruction to round a variable to n1 digits.

For example, given a residue calculation instruction with n1 digits being five digits and a residue calculation instruction with n2 digits being 4 digits, the deletion section 223 may delete the n1-digit residue calculation instruction, that is, the five-digit residue calculation instruction.

In step 9014, the deletion section 223 determines whether the use I causes no overflow in binary form. If no overflow in binary form is caused, the deletion section 223 proceeds to step 9015. If overflow in binary form is caused (if the use I inevitably causes overflow in binary form), the deletion section 223 determines that the use I is necessary (9016).

In step 9015, the deletion section 223 determines whether the numerator of the use I is signed. If the numerator of the use I is unsigned, the deletion section 223 proceeds to step 9017. If the numerator of the use I is signed, the deletion section 223 proceeds to step 9018. Whether the numerator of the use I is signed or unsigned may be determined on the basis of whether ZAP, which is an assembler language instruction, is used, or on the basis of what is set in a sign field of the decimal type variable. An exemplary way that may be employed for finding whether the numerator of the use I is signed or unsigned at the time of compilation is determining that the numerator is unsigned if F is set in the sign field of the decimal type variable, and determining that the numerator is signed if otherwise.

In step 9017, the deletion section 223 determines the necessity of the residue for each use K of the use I according to AnalyzeUSE(REM, K, NDIGITS), in response to the determination that the residue is unnecessary also for input in step 907 or the determination that the sign in decimal form is not changed in step 9018. AnalyzeUSE(REM, K, NDIGITS) is the same as in the flowchart of FIG. 9.

In step 9020, the deletion section 223 determines whether the residue is unnecessary for all uses K. If the residue is unnecessary for all the uses K, the deletion section 223 determines that the use K is unnecessary (9021). If the residue is not unnecessary for all the uses I, the deletion section 223 determines that the use K is necessary (9022).

In step 9018, the deletion section 223 determines whether the use I causes no change in sign in decimal form. If the use I causes no change in sign in decimal form, the deletion section (223) proceeds to step 9017. If the use I causes a change in sign in decimal form, the deletion section 223 determines that the use I is necessary (9019).

In step 909, the process AnalyzeUSE(REM, I, NDIGITS) for checking the necessity of the residue for each use I of the residue calculation instruction REM terminates.

FIG. 10 shows a flowchart of the process AnalyzeDEF(J, NDIGITS) for checking whether a residue is necessary or not for each definition J of the residue calculation instruction REM step 806 in the process of optimizing the residue calculation instruction shown in FIG. 8.

In step 1001, the deletion section 223 starts the processing of determining whether the definition J is necessary or not according to the process AnalyzeUSE(REM, I, NDIGITS) for checking the necessity of the residue for each definition J of the REM.

In step 1002, the deletion section 223 determines whether the number of digits and the sign of the definition J are both correct. If the number of digits and the sign of the definition J are both not correct, the deletion section 223 proceeds to step 1003. If the number of digits and the sign of the definition J are both correct, the deletion section 223 determines that the definition J is unnecessary (1004).

In step 1003, the deletion section 223 determines whether the residue is unnecessary also for output of the definition J if it is determined that residue is unnecessary for input of the definition J. If the residue is unnecessary also for the output, the deletion section 223 proceeds to step 1005. If the residue is not unnecessary also for the output, the deletion section 223 determines that the definition J is necessary (1006).

In step 1005, the deletion section 223 determines the necessity of the residue for each definition L of the definition J according to AnalyzeDEF(L, NDIGITS). AnalyzeDEF(L, NDIGITS) is the same as in the flowchart of FIG. 10.

In step 1007, the deletion section 223 determines whether the residue is unnecessary for all definitions L. If the residue is unnecessary for all the definitions L, the deletion section 223 determines that the residue is unnecessary for the definition L (1008). If the residue is not unnecessary for all the definitions L, the deletion section 223 determines that the residue is necessary for the definition L (1009).

In the optimization of the residue calculation instructions shown in FIG. 7, it is guaranteed that the number of digits of the operations of the residue calculation instructions is correct through the flowcharts shown in FIGS. 8 to 10. That is, if it is necessary to guarantee the correctness of the number of digits of an operation of a residue calculation instruction, the corresponding residue calculation instruction is determined to be necessary and is not deleted.

FIG. 11 is a diagram for illustrating what the VSET contains as the content of the set information included in the VSET, which is a working area, shown in step 608 of FIG. 6.

Depending on whether: (1) step 604 results in Yes; or (2) step 606 results in Yes; or (3) step 606 results in No, the VSET has different set information added thereto, or initialized, or unmodified, respectively.

A block 1101 indicates a portion of binary code. For example, the block 1101 includes accesses to variables V1 and V2, an instruction that can cause a side effect, and an access to the variable V1, from the top. Then, going down the code, ultimately the GEN(B) contains V1, and the KILL(B) contains V1 and V2.

In a block 1102, first, the content of the IN(B) is copied into the VSET. Next, because of the presence of the access to the variable V1, V1 is added to the VSET (step 605). Then, because of the presence of the access to the variable V2, V1 and V2 are added to the VSET (up to the point immediately before the instruction that can cause a side effect) (step 605). Then, because of the presence of the instruction that can cause a side effect, the VSET is initialized as an empty set (φ) (step 607). Then, because of the presence of the access to the variable V1 following the instruction that can cause a side effect, V1 is added to the VSET (step 605).

FIG. 12 shows COBOL code, binary code to be optimized, and code optimized by converting zoned decimal type variables into binary type variables according to an embodiment of the present invention.

The COBOL code 1201 is source code before being converted into the binary code 1202 to be optimized.

The binary code 1202 is code resulting from converting the COBOL code 1201 with a COBOL compiler.

The optimized code 1203 is binary code resulting from optimizing the binary code 1202 through the optimization technique according to an embodiment of the present invention.

In the COBOL code 1201, “01 dat PIC 9(7).” (line 1) indicates unsigned seven-digit numbers. It can be known, from F that is set in a sign field, that numbers are unsigned.

The processing section 222 rewrites a code portion 1212 shown in lines 3 to 8 in the binary code 1202 in an optimization target area detected by the detection section 221 as a code portion 1213 shown in lines 3 to 13 in the optimized code 1203. That is, the processing section 222 converts zoned decimal type variables in the binary code 1202 into binary type variables. The conversion results in the optimized code 1203.

In the optimized code 1203, two AHI codes would have respective codes of residue calculation instructions inserted immediately thereafter. However, through the optimization technique according to the present invention, it is only necessary to insert a residue calculation instruction immediately after the last AHI code. That is, codes of residue calculation instructions other than the last one residue calculation instruction in the binary code 1202 are removed. Accordingly, the last one residue calculation instruction in the binary code 1202 is executed.

Performances of the binary code 1202 and the optimized code 1203 were compared with respect to the number of cycles of instructions. As a result, a performance increase of about 1.1 times (computed with respect to the number of cycles of instructions) was observed through the above-described optimization.

The above-described optimization further allows another optimization. For example, a variation such that dat=dat+2 is facilitated.

FIG. 13 shows COBOL code, binary code to be optimized, and code optimized by converting zoned decimal type variables into binary type variables according to an embodiment of the present invention.

The COBOL code 1301 is source code before being converted into the binary code 1302 to be optimized.

The binary code 1302 is code resulting from converting the COBOL code 1301 with a COBOL compiler.

The optimized code 1303 is binary code resulting from optimizing the binary code 1302 through the optimization technique according to an embodiment of the present invention.

In the COBOL code 1301, variables A, B, and C all indicate unsigned seven-digit numbers. It can be known, from F that is set in a sign field, that numbers are unsigned. The variable A is operated as a binary number because “binary” is specified.

The processing section 222 rewrites a code portion 1312 shown in lines 5 to 19 in the binary code 1312 in an optimization target area detected by the detection section 221 as a code portion 1313 shown in lines 5 to 17 in the optimized code 1303. That is, the processing section 222 converts zoned decimal type variables in the binary code 1302 into binary type variables. The conversion results in the optimized code 1303.

In the optimized code 1303, three AR codes would have respective codes of residue calculation instructions inserted immediately thereafter. However, through the optimization technique according to the present invention, it is only necessary to insert a residue calculation instruction immediately after the last AR code (line 10). That is, codes of residue calculation instructions other than the last one residue calculation instruction in the binary code 1302 are removed. Accordingly, the last one residue calculation instruction in the binary code 1302 is executed.

Performances of the binary code 1302 and the optimized code 1303 were compared with respect to the number of cycles of instructions. As a result, the binary code 1302 involved 91 cycles, whereas the optimized code 1303 involved 27 cycles. Consequently, a performance increase of about 4.6 times (computed with respect to the number of cycles of instructions) was observed through the above-described optimization.

The above-described optimization further allows another optimization. For example, a variation such that dat=dat+2 is facilitated.

FIG. 14 shows COBOL code, binary code to be optimized, and code optimized by deleting pack/unpack binary codes for a variable that is updated idx according to an embodiment of the present invention.

The COBOL code 1401 is source code before being converted into the binary code 1402 to be optimized.

The binary code 1402 is code resulting from converting the COBOL code 1401 with a COBOL compiler.

The optimized code 1403 is binary code resulting from optimizing the binary code 1402 through the optimization technique according to an embodiment of the present invention.

In the COBOL code 1401, “01 dat PIC 9(7)” (line 1) indicates unsigned seven-digit numbers.

The binary code 1402 is an example in the case of a variable for which a write operation is performed in an area not including an instruction that can cause a side effect (i.e., a variable that is updated). It can be determined from the binary code 1402 that the variable is a variable that is updated.

The processing section 222 deletes, from the binary code 1402, an unpack code “UNPK 0(8,8),256(4,13)” in line 4 and its associated sign processing code “OI 7(8),X′F0′” in line 5, and a pack code “PACK 256(4,13),0(8,8)” in line 6 and its associated sign processing code “OI259(13),X′0F′” in line 7 in an optimization target area detected by the detection section 221. That is, the processing section 222 deletes the codes (lines 4 to 7) (1412) other than the first type conversion instruction (line 1) and the last type conversion instruction (line 2 from the end) among pack/unpack codes. The deletion results in the optimized code 1403.

Performances of the binary code 1402 and the optimized code 1403 were compared with respect to the number of cycles of instructions. As a result, in the same hardware environment, a performance increase of about 25% (computed with respect to the number of cycles of instruction) in the execution speed of the optimized code 1403 was observed compared with the execution speed of the binary code 1402 before optimization.

The above-described optimization further allows another optimization. For example, a variation such that dat=dat+2 is facilitated.

FIG. 15 shows COBOL code, binary code to be optimized, and code optimized by deleting a pack/unpack binary code for a variable that is not updated idx2 according to an embodiment of the present invention.

The COBOL code 1501 is source code before being converted into the binary code 1502 to be optimized.

The binary code 1502 is code resulting from converting the COBOL code 1501 with a COBOL compiler.

The optimized code 1503 is binary code resulting from optimizing the binary code 1502 through the optimization technique according to an embodiment of the present invention.

The COBOL code 1501 indicates signed seven-digit numbers, and it represents the optimization processing for the variable that is not updated idx2.

The binary code 1502 is an example in the case of a variable for which a write operation is not performed in an area not including an instruction that can cause a side effect (i.e., a variable that is not updated). It can be determined from the binary code 1502 that the variable is a variable that is not updated.

The processing section 222 deletes, from the binary code 1502, a pack code “PACK 256(16,13),40(7,8)” in line 5 and its associated sign processing code “OI271(13),X′0F′” in line 6 in an optimization target area detected by the detection section 221. That is, the processing section 222 deletes the codes (lines 5 to 6) other than the first type conversion instruction (line 1) among pack/unpack codes for the variable idx2. The deletion results in the optimized code 1503.

A PACK code (line 5 from the bottom) and an UNPK code (line 2 from the bottom), which are pack/unpack codes for the variable idx, may also be removed.

Performances of the binary code 1502 and the optimized code 1503 were compared with respect to the number of cycles of instructions. As a result, in the same hardware environment, a performance increase of about 9% (computed with respect to the number of cycles of instruction) in the execution speed of the optimized code 1503 was observed compared with the execution speed of the binary code 1502 before optimization.

What is claimed is:

1. An apparatus for optimizing binary codes in a language having access to a zoned decimal type variable, the apparatus comprising:
a detection section for detecting, for each variable, an area including access to a zoned decimal type variable and not including an instruction that possibly causes a side effect; and
a processing section for performing, in said detected area, at least one of a process for converting a zoned decimal type variable to a binary type variable and a process for deleting pack/unpack code such that a converted result does not change even upon a condition that the pack/unpack code is deleted from said binary codes.

2. The apparatus according to claim 1, further comprising a deletion section for deleting a code of a residue calculation instruction for digit alignment from said binary codes after said process is performed by said processing section,
wherein said deletion section:
(A) upon a condition that said variable is an n1-digit variable and a condition n1≧n2 is satisfied for a residue calculation instruction for making the variable an n2-digit variable, deletes a code of a residue calculation instruction for making said variable an n1-digit variable;
(B) upon a condition that case (A) does not apply,
(a) upon a condition that said variable is unsigned,
(a1) upon a condition that operations of addition, multiplication, or subtraction are continuous in said detected area and only in case the range of operations in which it can be guaranteed that no binary calculation overflow occurs is known at the time of compilation, deletes, from said binary codes, a code of a residue calculation instruction other than a code of the last residue calculation instruction among the guaranteed continuous operations;
(a2) upon a condition that case (a1) does not apply, guarantees that the number of digits is correct before an operation that does not satisfy (a1);
(b) upon a condition that said variable is signed,
(b1) upon a condition that operations of addition, multiplication, or subtraction are continuous in said detected area and only in case the range of operations in which it can be guaranteed that a sign does not change during the continuous operations and that no binary calculation overflow occurs is known at the time of compilation, deletes, from said binary codes, a code of a residue calculation instruction other than the last residue calculation instruction among the guaranteed continuous operations; and
(b2) upon a condition that (b1) does not apply, guarantees that the number of digits is correct before an operation that does not satisfy (b1).

3. An apparatus for optimizing binary codes in a language having access to a zoned decimal type variable, the apparatus comprising:
a memory for reading said binary codes;
a processor for optimizing said binary codes on said memory;
a detection section for detecting, for each variable, an area including access to a zoned decimal type variable and not including an instruction that possibly causes a side effect; and
a processing section for performing, in said detected area, at least one of a process for converting a zoned decimal type variable to a binary type variable and a process for deleting pack/unpack code such that a converted result does not change even upon a condition that the pack/unpack code is deleted from said binary codes.
